(19) United States
(12) Patent Application Publication
(10) Pub. No.: US 2026/0187611 A1
(43) Pub. Date: Jul. 2, 2026

(54) PRIVATE BLOCKCHAIN INTERFACE

(71) Applicant: Apple Inc., Cupertino, CA (US)

(72) Inventors: Quentin Eric Antonin CORBION, San Jose, CA (US); Varun A. VORA, San Jose, CA (US)

(21) Appl. No.: 19/002,671

(22) Filed: Dec. 26, 2024

(51) Int. Cl. G06Q 20/10; G06Q 20/36; G06Q 20/40; H04L 9/00

(52) U.S. Cl. CPC G06Q 20/10; G06Q 20/3674; G06Q 20/40; H04L 9/50; H04L 2209/56

(57) ABSTRACT

The subject technology may be used to provide off-chain transactions over established channels between user devices and a blockchain interface server. A transaction sending a blockchain asset from a first user to another user may be performed off-chain utilizing trusted partners and without settlement time and resources. The subject technology may also provide the ability to receive blockchain assets from non-user devices to user devices and send blockchain assets to non-user devices from user devices.

### TECHNICAL FIELD

The present description generally relates to facilitating an interfacing with one or more blockchain systems to provide the ability to transfer blockchain assets external to the blockchain in an efficient and privacy preserving manner.

### BACKGROUND

A blockchain represents an allocation of digitally based assets. The blockchain works by utilizing a shared ledger which is widely distributed among participants, and which represents a record of every transfer of a blockchain asset. When a transfer of a blockchain asset is made from one party to another, a settlement process updates the ledger, which is then eventually propagated to all the other distributed ledgers.

### BRIEF DESCRIPTION OF THE DRAWINGS

Certain features of the subject technology are set forth in the appended claims. However, for the purpose of explanation, several implementations of the subject technology are set forth in the following figures.

FIG. 1 illustrates an example network environment for validating a digital credential, in accordance with one or more implementations.

FIG. 2 depicts an example electronic device that may implement the subject methods and systems, in accordance with one or more implementations.

FIG. 3 depicts an example electronic device that may implement the subject methods and systems, in accordance with one or more implementations.

FIG. 4 depicts a sequence diagram of an example process for establishing channels between a blockchain interface server and an electronic device, in accordance with one or more implementations.

FIG. 5 depicts an infrastructure diagram, in accordance with one or more implementations.

FIG. 6 depicts a sequence diagram of an example process for transferring a blockchain asset from one user to another user, in accordance with one or more implementations.

FIG. 7 depicts a sequence diagram of an example process for transferring a blockchain asset from a user to a non-user, in accordance with one or more implementations.

FIG. 8 depicts a sequence diagram of an example process for transferring a blockchain asset from a non-user to a user, in accordance with one or more implementations.

FIG. 9 depicts a sequence diagram of an example process for transferring a blockchain asset from a user customer to a user merchant, in accordance with one or more implementations.

FIG. 10 depicts a flow diagram of an example process for establishing a channel between a user blockchain wallet and a blockchain interface server and using the channel to perform an operation transferring a blockchain asset, in accordance with one or more implementations.

FIG. 11 depicts a flow diagram of an example process for facilitating a transfer from a user blockchain wallet to another user blockchain wallet off-chain of the blockchain, in accordance with one or more implementations.

FIG. 12 depicts an example electronic system with which aspects of the present disclosure may be implemented, in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

A blockchain transaction essentially involves the writing of a signed data entry to a shared ledger, where the signed data entry assigns a blockchain asset to a blockchain wallet address, thereby representing the transfer of the blockchain asset. It should be understood that a blockchain asset can represent any sort of digitally represented asset, property, or right, such as money, contracts, deeds, medical records, customer details, images, data files, or any item that can be described in digital form. Each blockchain technology may differ in certain implementation details, but a transfer of a blockchain asset essentially involves the following steps. A first party sends the address of their wallet to a second party. The second party creates a transaction with the first party's wallet address as the destination of some identified blockchain asset and submits the transaction for validation to the peer-to-peer network of nodes. One or more of the nodes will validate the transaction according to the validation rules set by the blockchain technology. The validated transaction is then stored in a block and a hash value is created for the block. The block is added to the blockchain with a pointer back to the previous block in the blockchain. The added block is distributed via the peer-to-peer network of nodes to each machine with a copy of the ledger. Blockchain technologies have many advantages for securely tracking blockchain assets. Once added to the blockchain, a block cannot be altered without also altering its hash value, which if attempted would be rejected by the distributed peers because each hash value for each subsequent block would also have to be changed. While this process ensures that data, once added to the blockchain, cannot be altered, the process of adding to the blockchain is cumbersome and takes time to process. The time it takes between submission of a transaction to the blockchain for validation and the creation and distribution of a new block to the blockchain can be referred to as the settlement time.

There are several potential challenges with blockchain transactions which arise, depending on a desired use case for the transaction. One challenge is time and/or latency. Because settlement time for a blockchain transaction is not instantaneous and can take between 10 minutes and an hour, a blockchain transaction does not lend itself well to transactions between parties which are desired to take immediate effect and/or have immediate validation. Another challenge is transaction cost. The validation process noted above is performed by nodes of the peer-to-peer network. As a reward for their computing resources, they are provided a fee. Settlement time can be reduced by increasing the reward, but each settlement results in some transaction fee. This makes utilizing blockchain technology for small value transactions impractical as a larger percentage of the value of the blockchain asset is subsumed by the transaction fee. Another challenge is privacy. By nature, all transactions on the blockchain are public. If one wanted to, one could analyze the blockchain for statistical patterns involving particular wallets or track wallet addresses. When the first party provides their wallet address to the second party so that the second party can send a blockchain asset to the first party, the first party has essentially told the second party who they are and the second party could then share the identity information of the first party in relation to their wallet information and/or analyze the blockchain to correlate the first party with every transaction ever performed by the first party. Another challenge is notification. Even at the conclusion of the settlement time, there is no way of knowing that the transaction is settled except for downloading and reviewing the blockchain to see if it has been settled. This may be inefficient and/or inconvenient for the party waiting for confirmation.

Aspects of the subject technology address these challenges by instituting a private blockchain interface. The private blockchain interface provides a blockchain interface server to interface with the blockchain. When users have accounts associated with the blockchain interface server, transactions between such users with accounts can be performed off-chain, that is, apart from the official blockchain, which can later be settled back to the official blockchain. Transactions between a user with an account on the blockchain interface server (off-chain) and an external wallet (on-chain) can be negotiated by the blockchain interface server.

Aspects of the subject technology provide a wallet application (or wallet app) or another asset management application programmed to manage and/or maintain blockchain assets using subject processes. For the sake of simplicity, the application is referred to herein as a wallet application, but it should be understood that any other asset management application may be used in conjunction with the subject technology to manage blockchain assets in like manner. The wallet application is a software application which may be installed on a mobile device associated with a verified user account that securely manages interactions with a variety of transactional types of assets such as credit cards, mobile identification, airplane tickets, event passes, etc. The wallet application can include assets or credentials used to access assets. In the case of blockchain technologies, the wallet application can store a blockchain wallet address for a blockchain wallet. The blockchain wallet can also be referred to as the wallet or the wallet address. Others can, for example, send blockchain assets to a user's blockchain wallet via their blockchain wallet address. The wallet application can interact with a corresponding applet in the secure element to manage a private key for the blockchain wallet which is used to sign blockchain transactions. The wallet application track the value of their blockchain assets, for example, by aggregating values among different asset classes and/or different blockchain technologies and provide a seamless interface to the user. Aspects of the subject technology can be used to lock blockchain assets at the blockchain for use in off-chain transactions using payment channels between the blockchain interface server and the user's blockchain wallet and between the blockchain interface server and various supported blockchain technologies.

Aspects of the subject technology provide a secure environment related to the blockchain wallet to produce cryptographically signed transactions. The secure environment, for example, can be executed in a secure element of a user device. For ease of reference, the secure environment may be referred to as an applet, which may correspond to application code running in the secure environment, e.g., in the secure element.

Aspects of the subject technology can provide for device independent usage so that if a user loses their device or the device is stolen or destroyed, the user can retrieve and/or recreate their blockchain wallet from the blockchain interface server. Because the payment channels are between the user's blockchain wallet and the blockchain interface server, the blockchain interface server can reconcile the user's blockchain wallet if the wallet is lost.

Aspects of the subject technology can provide for conducting transactions in a privacy preserving manner. Transactions, for example, can be based on another user identifier, such as a user handle. The user handle can be used to obtain the blockchain wallet information for the receiving party in a process that is opaque to the sending party so that the blockchain wallet information for the receiving party is not easily obtainable by the sending party.

Aspects of the subject technology can provide the off-chain transactions without regard to the transaction cost of interacting with the blockchain. Because the blockchain interface server maintains the transactions off-chain, there are no settlement fees incurred with respect to the blockchain except for an initial transaction to commit or lock blockchain assets for use off-chain and a final transaction to release off-chain blockchain assets back to the blockchain. Transactions with external users may still incur a transaction cost.

Aspects of the subject technology provide for real-time, e.g., instantaneous or near instantaneous, such as within less than 30 seconds, such as between 0 and 10 seconds, transaction settlement time, thereby significantly reducing the time for confirmation for the user that a transaction is completed. Thus, the subject technology enables instant transactions between parties who are users associated with the blockchain interface server. Such parties can include, for example, users of a device platform, such as a smartphone. Such parties can also include customers and merchants, and the subject technology can be used to transfer blockchain assets from a customer to a merchant, for example, at a merchant website or at a merchant location (e.g., using a contactless transaction, such as an NFC tap transaction).

Aspects of the subject technology provide for a user-friendly notification mechanism. As noted above, settlement of a typical blockchain transaction does not inherently result in any notification. The blockchain has to be polled to determine if the settlement has occurred or not. In user-to-user transactions, on the other hand, the blockchain interface server can provide active notification and confirmation that a transaction has successfully (or unsuccessfully) completed. In user-to-nonuser or nonuser-to-user transactions, the blockchain interface server can perform the polling to determine that settlement has occurred and notify the user (and optionally the nonuser) that the settlement has occurred.

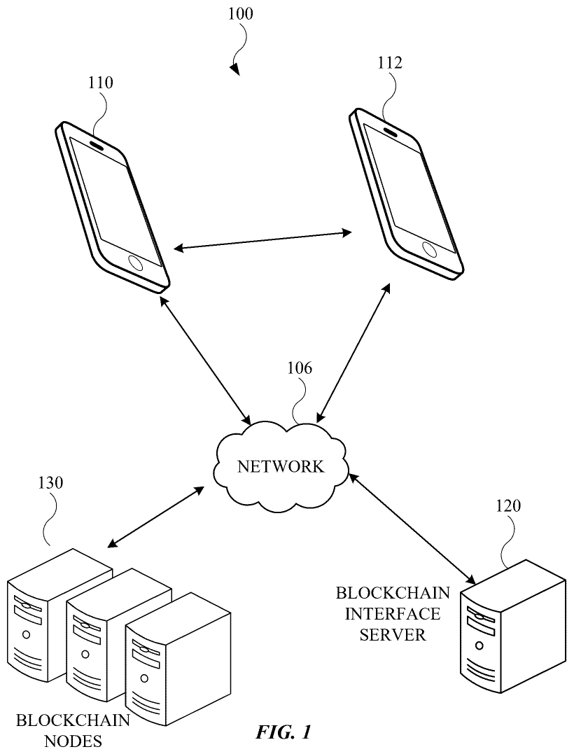

FIG. 1 illustrates an example network environment 100 for creating a user wallet, e.g., a blockchain wallet, and establishing channels to a user blockchain asset for off-chain transactions, in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 may include an electronic device 110, another electronic device 112, one or more servers (e.g., blockchain interface server 120), and blockchain nodes 130. The network 106 may communicatively (directly or indirectly) couple the electronic device 110, the electronic device 112, the blockchain interface server 120, and/or the blockchain nodes 130, in accordance with some implementations. In one or more implementations, the network 106 may be an interconnected network of devices that may include, or may be communicatively coupled to, the Internet. For explanatory purposes, the network environment 100 is illustrated in FIG. 1 as including the electronic device 110, the electronic device 112, the blockchain interface server 120, and the blockchain nodes 130; however, the network environment 100 may include any number of electronic devices and/or any number of servers communicatively coupled to each other directly or via the network 106.

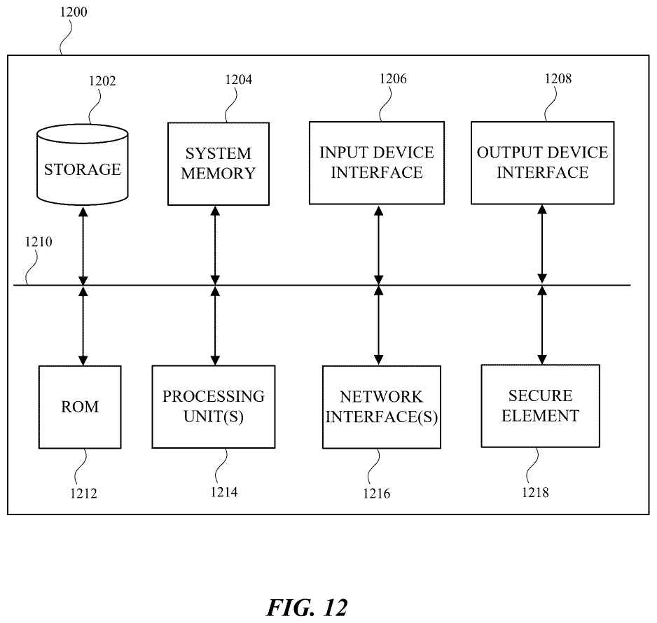

The electronic device 110 and the electronic device 112 may each be, for example, a wearable device such as a watch, a band, and the like, a desktop computer, a portable computing device such as a laptop computer, a smartphone, a peripheral device (e.g., a digital camera, headphones), a merchant point of sale device, a tablet device, or any other appropriate device that includes, for example, one or more wireless interfaces, such as WLAN radios, cellular radios, Bluetooth radios, Zigbee radios, near-field communication (NFC) radios, and/or other wireless radios. In FIG. 1, by way of example, the electronic devices 110 and 112 are depicted as smartphones. The electronic devices 110 and 112 may be, and/or may include all or part of, the electronic system discussed below with respect to FIG. 12. The electronic devices 110 and 112 may each include one or more digital wallet applications. The electronic devices 110 and 112 may each also be associated with a respective user account. For example, the electronic device 110 may be registered to a user account at the blockchain interface server 120. For example, the electronic device 112 may also be registered to a user account at the blockchain interface server 120. In some implementations, the electronic device 112 may not be registered to a user account at the blockchain interface server 120. The electronic devices 110 and 112 may also include an NFC reader and/or transmitter, enabling the electronic devices 110 and 112 to interact with other NFC-enabled devices or objects within a close range, such as a few centimeters. When activated, the NFC reader may generate an electromagnetic field that powers an NFC tag, allowing for the transfer of data such as payment information, digital identification cards, or smart home commands. Digital payments utilizing the NFC reader and/or transmitting may be secured through encryption and tokenization, so that sensitive information is protected during transactions. The electronic devices 110 and/or 112 may also include a secure element or other trusted execution environment to host a secured application for storing information for wallet credentials for the wallet application and for performing cryptographic operations.

The blockchain interface server 120 may facilitate interoperability and/or communication between electronic device 110 (or between the electronic device 112) and the blockchain interface server 120 and between the blockchain interface server 120 and the blockchain nodes 130. The blockchain interface server 120 may receive requests or data from an electronic device, then act on such requests to cause a transfer of a digital asset, such as a blockchain asset, to occur between such electronic device and another electronic device associated with the blockchain interface server 120 (e.g., for an off-chain transaction) or another electronic device associated with the blockchain nodes 130 (e.g., for an on-chain transaction). Additionally, the blockchain interface server 120 can provide services such as locking blockchain assets at the blockchain nodes 130 and facilitating transactions with the blockchain nodes 130. Further, the blockchain interface server 120 can provide services for monitoring the blockchain and providing alerts or notifications to the electronic devices 110 and/or 112 for on-chain and off-chain transactions. In addition, the blockchain interface server 120 can provide services such as data encryption and decryption to maintain the security and privacy of the transmitted information and/or perform authentication and authorization functions, verifying the identities of devices and users to prevent unauthorized access. The blockchain interface server 120 may be, and/or may include all or part of, the electronic system discussed below with respect to FIG. 12.

The blockchain nodes 130 may correspond to the nodes of one or more blockchain technologies. The blockchain nodes 130 may correspond, for example, to various distributed server nodes for performing validation and propagation services for requests to update a blockchain stored at each of the blockchain nodes 130 for the one or more blockchain technologies.

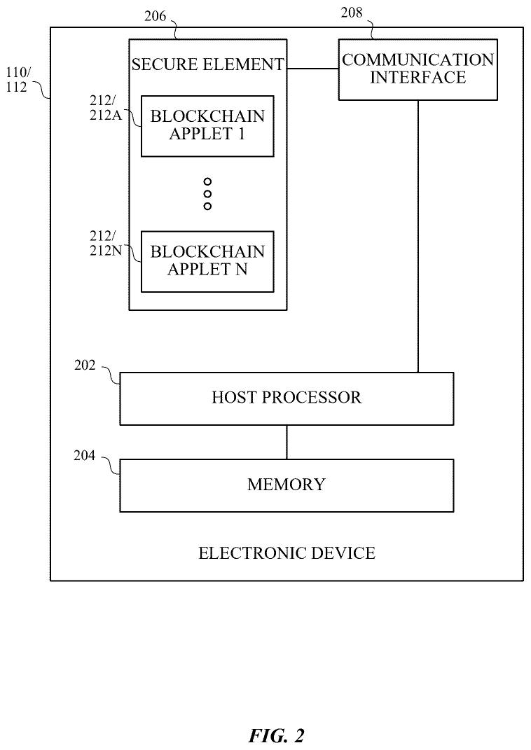

FIG. 2 depicts an example electronic device 110 and/or 112 that may implement the subject methods and systems, in accordance with one or more implementations. For explanatory purposes, FIG. 2 is primarily described herein with reference to the electronic device 110 and/or 112 of FIG. 1. However, this is merely illustrative, and features of the electronic device of FIG. 2 may be implemented in any other electronic device for implementing the subject technology. Not all of the depicted components may be used in all implementations, however, and one or more implementations may include additional or different components than those shown in FIG. 2. Variations in the arrangement and type of the components may be made without departing from the spirit or scope of the claims as set forth herein. Additional components, different components, or fewer components may be provided.

The electronic device 110 and/or 112 may include one or more of a host processor 202, a memory 204, a secure element 206, and/or a communication interface 208. The host processor 202 may include suitable logic, circuitry, and/or code that enable processing data and/or controlling operations of the electronic device 110 and/or 112. In this regard, the host processor 202 may be enabled to provide control signals to various other components of the electronic device 110 and/or 112. The host processor 202 may also control transfers of data between various portions of the electronic device 110 and/or 112. The host processor 202 may further implement an operating system or may otherwise execute code to manage operations of the electronic device 110 and/or 112.

The memory 204 may include suitable logic, circuitry, and/or code that enables storage of various types of information such as received data, generated data, code, and/or configuration information. The memory 204 may include volatile memory (e.g., random access memory (RAM)) and/or non-volatile memory (e.g., read-only memory (ROM), flash, and/or magnetic storage). In one or more implementations, the memory 204 may store applications and application data (e.g., digital credentials).

The communication interface 208 may include suitable logic, circuitry, and/or code that enables wired or wireless communication, such as between the electronic device 110 and/or 112 and the blockchain interface server 120. The communication interface 208 may include, for example, one or more of a Bluetooth communication interface, an NFC interface, a Zigbee communication interface, a WLAN communication interface, a universal serial bus (USB) communication interface, a cellular interface, an ultrawide band (UWB) interface, or generally any communication interface. In some implementations, the communication interface 208 may include an NFC controller including one or more antennas and one or more transceivers for transmitting/receiving NFC communications.

The secure element 206 may include hardware that provides secure storage and management of sensitive information. The secure element 206 may be securely isolated from the host processor 202 and operating system, making it more difficult for unauthorized access. The secure element 206 may be used for secure transactions and/or identification, such as payment credentials, digital passes, and the like. The secure element 206 may store sensitive information, such as cryptographic keys or digital credentials, and may protect the sensitive information with cryptographic algorithms and access controls. For example, the secure element 206 may include a hardware specific private key that is provisioned on the secure element 206 at or near the time of manufacture. The use of the secure element 206 provides an additional layer of security for sensitive information and helps to ensure its confidentiality in case the electronic device 110 and/or 112 is lost or compromised.

The secure element 206 may include one or more interfaces for communicatively coupling (directly or indirectly) to the communication interface 208 (e.g., NFC controller) and/or the host processor 202. The secure element 206 may include one or more blockchain applets 212A-N, which may be referred to herein singularly as applet 212 or plurally as applets 212. Each applet 212 can correspond to a particular blockchain technology in some implementations, while in other implementations one applet 212 can be used for all blockchain technologies. In one or more implementations, the operating system and/or execution environment of the secure element 206 may be a JAVA-based operating system and/or JAVA-based execution environment, and the applets 212A-N may be JAVA-based applets. In other implementations, other operating systems, languages, and/or environments can be implemented. In addition to the one or more applets 212, the secure element 206 may also include one or more additional applets for performing other operations, such as a security applet, a registry applet, and the like. The blockchain interface server 120 may interact with a wallet application on the electronic device 110 and/or 112 which, in turn, can interact with the applets 212, as described further herein.

In one or more implementations, all or part of the secure element 206 may be implemented by the host processor 202, and therefore, in one or more implementations, the secure element 206 may not be included in the electronic device 110 and/or 112.

In one or more implementations, one or more of the host processor 202, the memory 204, the secure element 206, the communication interface 208, and/or one or more portions thereof may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

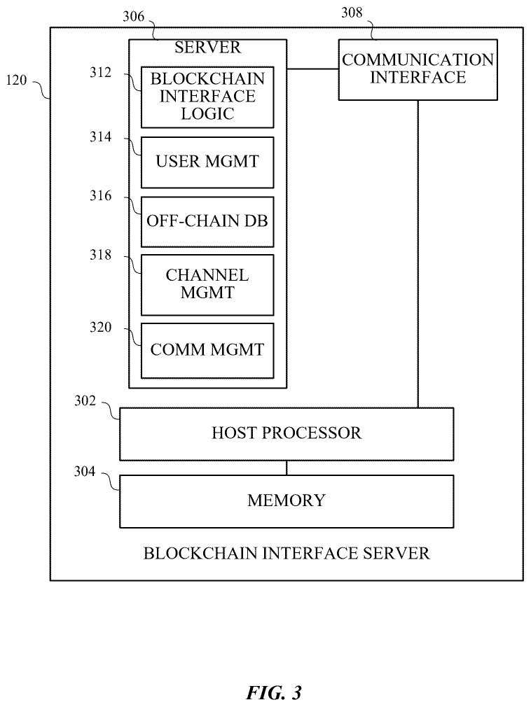

FIG. 3 depicts an example blockchain interface server 120 that may implement the subject methods and systems, in accordance with one or more implementations. For explanatory purposes, FIG. 3 is primarily described herein with reference to the blockchain interface server 120 of FIG. 1. However, this is merely illustrative, and features of the electronic device of FIG. 3 may be implemented in any other electronic device for implementing the subject technology. Not all of the depicted components may be used in all implementations, however, and one or more implementations may include additional or different components than those shown in FIG. 3. Variations in the arrangement and type of the components may be made without departing from the spirit or scope of the claims as set forth herein. Additional components, different components, or fewer components may be provided.

The blockchain interface server 120 may include one or more of a host processor 302, a memory 304, a server logic group 306, and/or a communication interface 308. The host processor 302 may include suitable logic, circuitry, and/or code that enable processing data and/or controlling operations of the blockchain interface server 120. In this regard, the host processor 302 may be enabled to provide control signals to various other components of the blockchain interface server 120. The host processor 302 may also control transfers of data between various portions of the blockchain interface server 120. The host processor 302 may further implement an operating system or may otherwise execute code to manage operations of the blockchain interface server 120.

The memory 304 may include suitable logic, circuitry, and/or code that enables storage of various types of information such as received data, generated data, code, and/or configuration information. The memory 304 may include volatile memory (e.g., random access memory (RAM)) and/or non-volatile memory (e.g., read-only memory (ROM), flash, and/or magnetic storage). In one or more implementations, the memory 304 may store server applications and server application data (e.g., off-chain transaction data, user blockchain wallet information, channel information).

The communication interface 308 may include suitable logic, circuitry, and/or code that enables wired or wireless communication, such as between the blockchain interface server 120 and the electronic device 110 and/or 112 or between the blockchain interface server 120 and the blockchain nodes 130. The communication interface 308 may include, for example, one or more of a Bluetooth communication interface, an NFC interface, a Zigbee communication interface, a WLAN communication interface, a universal serial bus (USB) communication interface, a cellular interface, an ultrawide band (UWB) interface, or generally any communication interface.

Although not illustrated in FIG. 3, the blockchain interface server 120 may also include a secure element, which may be used to perform functions related to the creation and management of the channels between the blockchain interface server 120 and the blockchain nodes 130 and between the blockchain interface server 120 and the electronic devices 110 and/or 112. The secure element may be similar to that described above with respect to FIG. 2, except any applets would be for server-level cryptographic processes and/or other secure server processes. It is expected that the blockchain interface server 120 would enable best security practices and thus be robustly protected against malicious actors. In one or more implementations, all or part of the functions corresponding to a secure element may be implemented by the host processor 302, and therefore, in one or more implementations, the secure element may not be included in the blockchain interface server 120.

The server logic group 306 may include various server modules or server applications for performing the functionality of the blockchain interface server 120. The server logic group 306 may include, for example, blockchain interface logic 312, user management services 314, off-chain transaction tracking 316, and channel management services 318. The blockchain interface logic 312 may include functionality and programs for interfacing with one or more blockchain technologies, for example, by accessing and monitoring the blockchain for blockchain updates following lock requests or requests to write a transaction to the blockchain.

The user management services 314 of the server logic group 306 may include functionality and programs for providing user tools, such application programming interfaces (APIs) for interoperability with the user's devices, such as the electronic device 110 and/or 112. The APIs for example can respond to formatted requests to retrieve user wallet address information, balance information, channel information, and so forth. In one or more implementations for example, the user management services 314 may receive an API request including a username or user handle of a user of the blockchain interface server 120 and respond in a manner which is opaque to the requesting device, with a wallet address of the user corresponding to the username or user handle. In some implementations, the wallet address may be encrypted in a manner which can only be decrypted by an applet running in the secure element of the electronic device 110 and/or 112.

The off-chain transaction tracker 316 can provide functionality and programs for storing off-chain transactions, for example, between and among users of the blockchain interface server 120. The off-chain transactions, for example, may include an aggregation of transactions from user to user which are committed to the blockchain at a later time. Because the blockchain interface server 120 is considered trustworthy, concerns that may arise in other off-chain solutions are not present. For example, another off-chain solution may include setting up an off-chain channel directly between two users. Each off-chain transaction represents a promise to pay, but because neither of the users is trustworthy further safeguards are used to ensure that one of the users cannot act nefariously. Such safeguards may include, for example, issuing timelocks and revocation secrets between transacting parties to enable revocation in the event one party acts nefariously or in an anomalous manner. In some implementations, such safeguards are not needed since the blockchain interface server 120 is trustworthy. In other implementations, one or more strategies can be used to provide for revocation and timelock of blockchain assets involved in off-chain transactions. In some implementations, deterministic keys may be used for issuing transactions between users. In such instances, user wallet address information can be recreated in the event the user loses their device.

For transactions between users associated with the blockchain interface server 120, the off-chain transaction tracker 316 can track transactions using any suitable strategy. In one example, the transactions can be tracked in a database that tracks blockchain assets transferred for each user and maintains a balance sheet for each user or can derive a balance sheet for each user based on the transactions. In another example, the transactions can be maintained as a type of sub-blockchain ledger, essentially using blockchain technology to create a shared ledger amongst users. In another example, the transactions can be maintained both at the blockchain interface server 120 and copies of transactions may be maintained at the individual user wallet applications.

The channel management services 318 can provide functionality and programs for opening and closing channels between the blockchain interface server 120 and user devices and between the blockchain interface server 120 and one or more blockchain technologies. The channels may be referred to as payment channels. When a channel is opened, a capacity for the channel is determined based on the amount of blockchain asset locked at the blockchain in response to a request received from a wallet application on an electronic device. Then, the channel can be used to provide transactions from one user to another user, using the blockchain interface server 120 as an intermediary to record the transaction from one electronic device, e.g., electronic device 110, of a user of the blockchain interface server 120 to another electronic device, e.g., electronic device 112, of another user of the blockchain interface server 120, and send notifications to the users on either end of the transaction.

The communications management services 320 can provide functionality and programs for notifying users with accounts at the blockchain interface server 120 that blockchain assets are locked, unlocked, sent, or received. The communications management services 320 can provide an application programming interface (API) to receive requests from the other modules of the server logic group to send notifications based on statuses. For example, if the blockchain interface logic 312 observes that a transaction was written to the blockchain with an address corresponding to a wallet of a user of the blockchain interface server 120, then the blockchain interface logic 312 can request the communications management services 320 to notify the user associated with that wallet address with details regarding the transaction written to the blockchain. Similarly, when the off-chain transaction tracker 316 processes transactions between users of the blockchain interface server 120, the off-chain transaction tracker 316 can request the communications management services 320 to send appropriate notifications to the users involved in the transactions.

In one or more implementations, one or more of the host processor 202, the memory 204, the communication interface 208, and/or one or more portions thereof may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hard ware components, or any other suitable devices) and/or a combination of both.

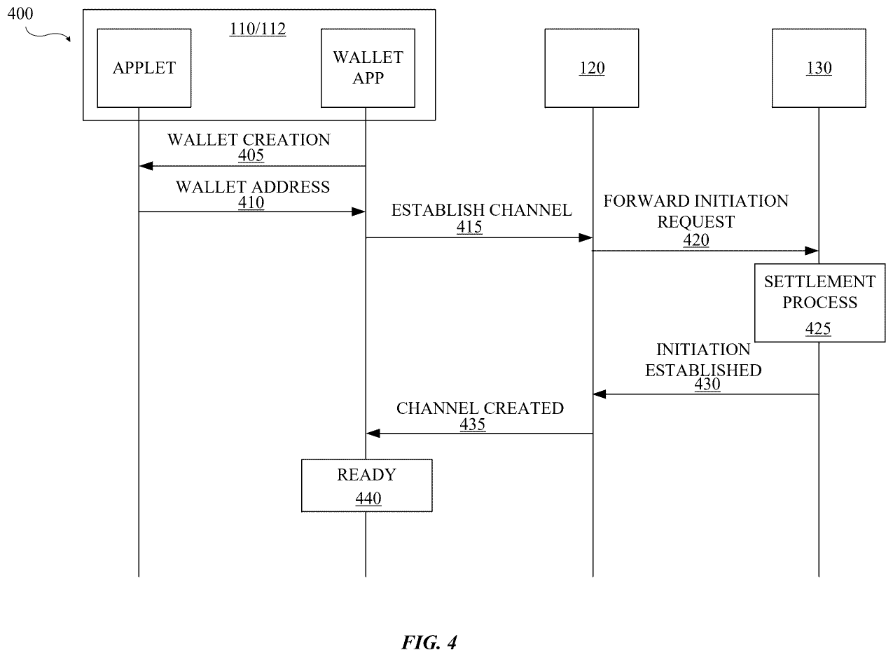

FIG. 4 depicts a sequence diagram of a process 400 for creating a channel for securely transferring signed data, e.g., a payment channel, between a wallet application of a user device and the blockchain interface server 120 and one or more channels between the blockchain interface server 120 and one or more respective blockchain technologies. For explanatory purposes, the process 400 is primarily described herein with reference to the electronic device 110 and/or 112, the blockchain interface server 120, and the blockchain nodes 130 of FIGS. 1-3. However, the process 400 is not limited to the electronic device 110 and/or 112, the blockchain interface server 120, or the blockchain nodes 130. Further, for explanatory purposes, the periods of the process 400 are described herein as occurring sequentially or linearly. However, multiple periods of the process 400 may occur in parallel. In addition, the periods of the process 400 need not be performed in the order shown and/or one or more periods of the process 400 need not be performed and/or can be replaced by other operations.

At period 405, a wallet application on the electronic device 110 and/or 112 may request the creation of a blockchain wallet from an applet running in the secure element of the electronic device 110 and/or 112. For example, a user may launch a digital wallet application on their electronic device 110 and/or 112. The digital wallet may be a software application designed to manage payment credentials and/or facilitate financial transactions and may serve as the interface through which the user interacts with a broader payment ecosystem. Upon launching the digital wallet application, the user may be presented with various options, including adding or provisioning a wallet for holding blockchain assets. A user interface element of the digital wallet application may prompt the user to request creation of one or more blockchain wallets (i.e., one for each type of blockchain technology for which a blockchain wallet is being requested). Upon receiving a user request to create a wallet, the wallet application can request an applet at the secure element of the electronic device 110 and/or 112 to create the wallet by generating private keys and/or public keys to enable the transfer of blockchain assets using the private key and the receipt of blockchain assets via the public key. It some implementations, the generation of the keys can be based on a unique value associated with the electronic device 110 and/or 112, such as a unique id associated with the secure element. In some implementations, the generation of the keys can utilize a deterministic process such that the keys can be regenerated should the device become lost or destroyed. In some implementations, the creation of the blockchain wallet may include a process to import keys of an existing blockchain wallet in the possession or control of the user.

At period 410, the applet creates the blockchain wallet, e.g., by creating the keys and returning one or more of the keys to the wallet app. For example, the private key can be kept in the secure element for safeguarding and the public key can be made available to the wallet app. The blockchain wallet can then be funded, for example, by recording an on-chain transaction to the blockchain with the wallet address as a destination address for receiving a blockchain asset. For example, in the case where the asset is a digital currency, the user can exchange one currency for the digital currency according to an exchange rate. In another example, the user may own some of the blockchain asset in another blockchain wallet and may transfer some of the blockchain asset from that wallet to their wallet. In another example, the creation of the blockchain wallet may include importing private keys associated with an existing wallet into the applet.

At period 415 the wallet app can request to establish a channel, such as a payment channel via the blockchain interface server 120. The mechanism to establish a channel may depend on the blockchain technology. The channel can be considered, a specialized multi-signature address that exists between two parties. Each of the two parties of the payment channel must sign a transaction with their private key in order to effectuate use of the channel. Thus, establishing the channel between the wallet app for the electronic device 110 or 112 and the blockchain interface server 120 can include generating an address for the channel. This enables any use of the payment channel by either party to require digitally signing any transaction at both ends with a private key. Once the multi-signature address has been established, the wallet app can initiate an initiation transaction, such as a funding transaction, to the multi-signature address. The initiation transaction can correspond to the assignment of digital properties of the blockchain technology to the multi-signature address. In some instances, these may correspond to a digital asset with some exchangeable monetary value. In other instances, these may correspond to a digital asset for another purpose, such as for data files, data quotas, or a countable asset.

At period 420, the blockchain interface server 120 can forward the initiation transaction for the channel to the blockchain nodes 130 corresponding to one or more blockchain technologies. In the present example, the blockchain can lock an amount of the blockchain asset at the blockchain level. In a settlement process at period 425, the transaction information can be validated by the blockchain nodes 130 and the lock information added to the blockchain.

At period 430, the blockchain interface server 120 can poll the blockchain to determine when the settlement process at period 425 is completed. When the blockchain interface server 120 determines that the settlement process is completed, this indicates that the initiation has settled, and the channel was successfully initiated. Therefore, at period 435, the channel is established according to the size of the blockchain assets identified during the request to establish the channel during period 415.

At period 440, the wallet app can update a user interface to notify the user of the electronic device 110 or 112 that the blockchain assets are available in the wallet app. In the case where the blockchain assets represent a digital currency, for example, the wallet app can provide in a user interface for the wallet app an indication of the amount of digital currency available to transact, where the amount corresponds to the amount locked at the blockchain. In some instances, if the digital currency has a corresponding trade value in another currency, an equivalent value, such as a US Dollar value, Euro value, or British Pound value can also be displayed based on the trade value.

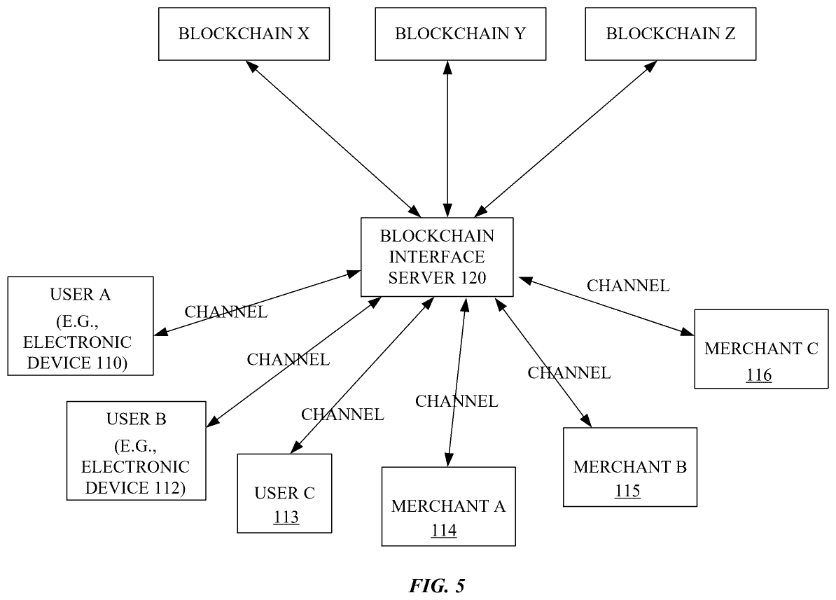

FIG. 5 illustrates a representation of an interconnection architecture according to the subject technology. The blockchain interface server 120 sits at the center. Access to blockchain X, blockchain Y, and blockchain Z can be undertaken by the blockchain interface server 120 to interact with each of the respective blockchains, for example, to lock blockchain assets on each of the blockchains, to settle aggregated off-chain transactions back to the appropriate corresponding blockchains, and to monitor the blockchains for updates to blockchain wallet addresses associated with users of the blockchain interface server 120. The blockchain X, blockchain Y, and blockchain Z represent any appropriate blockchain technology, including cryptocurrencies, such as Bitcoin, Ethereum, Tether, XRP, Litecoin, Dogecoin, Avalanche, and Solana, and so forth. FIG. 5 further illustrates a relationship between User A (e.g., a user of electronic device 110) and the blockchain interface server 120, the relationship including a channel, such as a payment channel established between the electronic device 110 and the blockchain interface server 120. The illustrated channels, for example, can be established using a procedure, such as described with respect to FIG. 4. User A, for example, may have a user account associated with the blockchain interface server 120. Further, the blockchain interface server 120 may be a part of a larger services platform, for example, providing entertainment services, music services, work productivity services, email services, phone services, data services, storage services, health tracking services, and so forth. Further, the blockchain interface server 120 may be operated by a manufacturer of the electronic device 110 in a cohesive ecosystem of user devices and system servers. User A, therefore, may have a user id associated with the blockchain interface server 120 that spans across various services of the ecosystem. The blockchain interface server 120 can store the address of the User A's blockchain wallet at the electronic device 110 in connection with User A's user id.

Each channel illustrated in FIG. 5 may correspond to a channel, such as a payment channel, between a user or merchant and the blockchain interface server 120. For example, User B (e.g., a user of electronic device 112) may have a relationship to the blockchain interface server 120 including a channel. The blockchain interface server 120 may further store User B's user id in connection with a blockchain wallet at the electronic device 112. User C (e.g., a user of an electronic device 113) may likewise have a channel established between the electronic device 113 and the blockchain interface server 120. Merchants, such as sellers of goods or providers of services, may also have accounts associated with the blockchain interface server 120 and channels, such as a payment channel, established between devices for the merchants and the blockchain interface server 120. For example, Merchant A (e.g., a user of an electronic device 114) may have a channel established between the electronic device 114 and the blockchain interface server 120. In the case of a merchant, the electronic device 114 may, for example be a point-of-sale system which can accept a tap transaction over NFC. Similarly, Merchant B and Merchant C (users of electronic devices 115 and 116, respectively) may have respective channels established between the electronic device 115 and the blockchain interface server 120 and between the electronic device 116 and the blockchain interface server 120. Electronic devices 113, 114, 115, and 116 may correspond to a device like unto the electronic device 110 and/or 112, described above.

It should be appreciated that each user may include one or more channels established between the electronic devices, e.g., one for each blockchain, though it is not required for a particular electronic device to have a channel for each available blockchain technology.

When User A wants to send a blockchain asset to User B or to Merchant A, and so forth, as described in greater detail below, the interconnection architecture provides that the User A can send the blockchain asset to User B off-chain using the blockchain interface server 120 as an intermediary to forward the blockchain asset to User B. In contrast, other systems may require a channel to be established directly between User A and User B. A direct channel arrangement is disadvantageous because direct channels have to be set up and maintained by each user and they should take extra precautions because neither party knows if the other is trustworthy. In contrast, the blockchain interface server 120 is trusted. Other architectures may provide for transaction forwarding over channels between directly connected electronic devices, however, forwarding transactions in this manner may involve signing each transaction by each device along the way. The architecture illustrated in FIG. 5, however, necessitates provides only one forwarding operation.

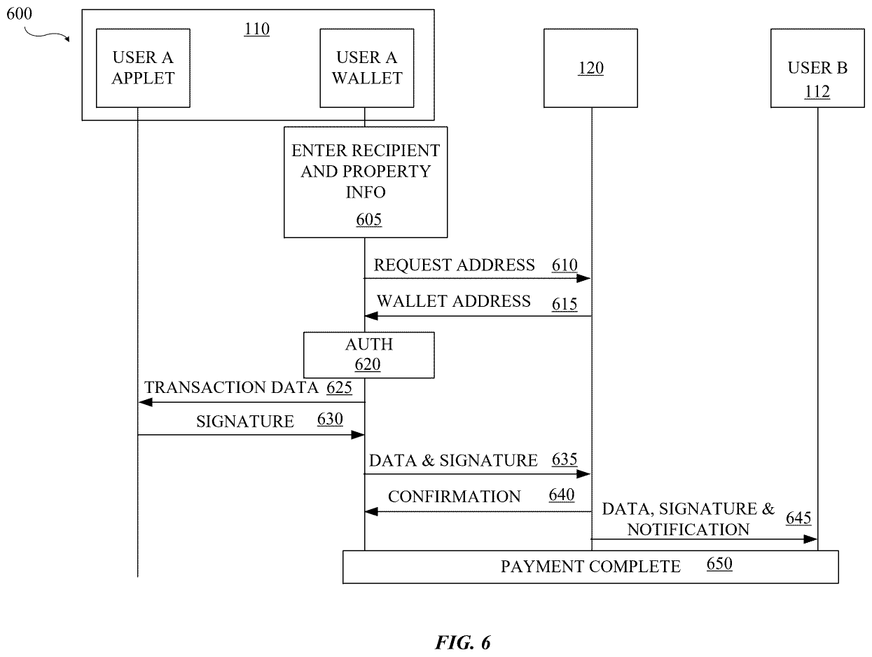

FIG. 6 depicts a sequence diagram of an example process 600 sending a blockchain asset from User A to User B, where each of User A and User B are customers or users associated with the blockchain interface server 120. The electronic device 110 is associated with User A, e.g., belongs to User A or which User A is a primary user of, and includes a wallet app and an applet in a secure element, such as described above. For explanatory purposes, the process 600 is primarily described herein with reference to the electronic device 110 and 112 and the blockchain interface server 120 of FIGS. 1-3. However, the process 600 is not limited to the electronic device 110 and/or 112 or the blockchain interface server 120. Further, for explanatory purposes, the periods of the process 600 are described herein as occurring sequentially or linearly. However, multiple periods of the process 600 may occur in parallel. In addition, the periods of the process 600 need not be performed in the order shown and/or one or more periods of the process 600 need not be performed and/or can be replaced by other operations.

At period 605, User A may launch a digital wallet application on their electronic device 110. The digital wallet may provide an interface where User A can provide a user id or other identifying characteristic of a recipient (User B) to send blockchain asset to and an amount corresponding to the blockchain asset, for example, a number of data elements of the blockchain asset. The other identifying characteristic may be, for example, a phone number associated with the recipient, a contact data object of the recipient, or an email address of the recipient, or the like. The user may be presented with a confirmation interface to verify the transaction and a user interface element, such as a software button or a physical hardware button to submit the transaction.

At period 610, upon submission of the transaction, the wallet application can reconcile the recipient information, e.g., User B's user id, to a wallet identifier, such as an address, of the recipient (User B). The wallet application can, for example, query the blockchain interface server 120 and provide the recipient information to the blockchain interface server 120.

At period 615, in response, the wallet application can receive from the blockchain interface server 120 a wallet address for the recipient User B. This process of querying the blockchain interface server 120 and receiving the wallet address may be opaque to the user, who can be prevented from seeing the wallet address. In such a manner, the wallet address of the recipient may be hidden from User A. In some implementations, User B's wallet address may be encrypted prior to transmission to the user's wallet app for more robust privacy. The encrypted wallet address may be provided to the applet in the secure element of User A's device (i.e., the electronic device 110), and the applet can decrypt the encrypted wallet address. In such a manner, User A is prevented from accessing User B's wallet address, as there is no way for User A to access the data in the secure element.

At period 620, prior to submitting the transaction to the applet in the secure element for processing, an authorization process can be used to verify that the user, e.g., User A, has authorization to sign a digital transaction to transfer a blockchain asset from the wallet address. In some implementations, the authorization process may involve analyzing biometric data of User A and comparing the biometric data to known good data of User A. For example, a face scan, eye scan, or fingerprint scan of User A can be compared to a face scan, eye scan, or fingerprint on file at the electronic device 110. In some implementations, the authorization process may involve a password or personal identification number (PIN). In some implementations, the authorization process may involve a two-factor authentication. Other implementations, may utilize any of the above individually or in combination. The authorization process may be conducted at other periods in the process 600, such as before or after period 605 or after period 630.

At period 625, the transaction data is provided to the applet in the secure element. The transaction data includes the wallet address (or the encrypted wallet address) and the amount of blockchain asset to be transferred. At period 630, the applet will process the transaction data and form a transaction including the recipient address. In implementations where the recipient and addresses received in an encrypted form, the applet may decrypt the recipient address prior to forming the transaction. The applet will cryptographically sign the transaction using the private key and provide the signed transaction data or the signature alone to the wallet application at the electronic device 110.

At period 635, the wallet application uses the channel between the electronic device 110 and the blockchain interface server 120 to provide the transaction information including the transaction data and the signature to the blockchain interface server 120. And at period 640, the blockchain interface server 120 can provide a confirmation back to User A's wallet application indicating that the transaction information was received by the blockchain interface server 120.

At period 645, the blockchain interface server 120 can store the transaction information and forward the transaction information including the transaction data and the signature to User B's electronic device 112, based on the wallet address. For example, the blockchain interface server 120 can analyze the transaction information to derive the recipient wallet address (or the channel address for the channel between the blockchain interface server 120 and the electronic device 112) and record the transaction at the blockchain interface server in an off-chain transaction. Further, the blockchain interface server 120 can send a copy of the transaction information to the recipient (User B). Along with the sending of the transaction information to the electronic device 112, a notification can be sent which causes a user interface of the electronic device 112 to notify User B that blockchain assets were received.

At period 650, the payment is considered complete, though it is still off-chain. In some implementations, the blockchain interface server 120 can periodically settle the blockchain assets still associated with each wallet application back to the blockchain. In such implementations, the blockchain interface server 120 can optionally reregister a lock on blockchain assets associated with the user account. For example, in some blockchain technologies, a channel may expire after a time period. Such associated channels may be written out to the block chain and relocked as needed in an additional channel creation process.

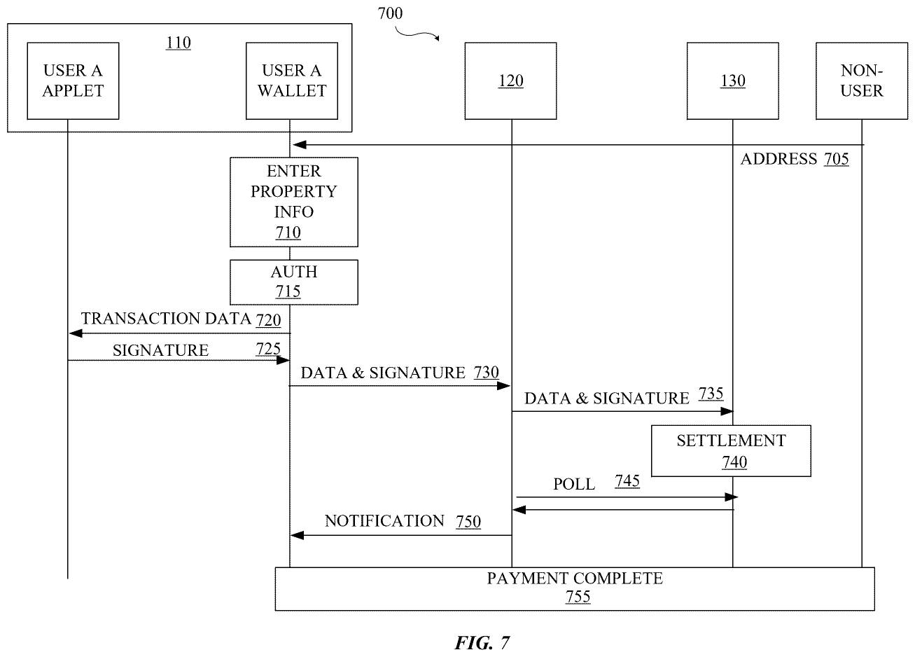

FIG. 7 depicts a sequence diagram of an example process 700 sending a blockchain asset from User A to a non-user, where User A is a customer or user associated with the blockchain interface server 120 and the non-user is not. The electronic device 110 is associated with User A, e.g., belongs to User A or which User A is a primary user of, and includes a wallet app and an applet in a secure element, such as described above. For explanatory purposes, the process 700 is primarily described herein with reference to the electronic device 110, the blockchain interface server 120, and the blockchain nodes 130 of FIGS. 1-3. However, the process 700 is not limited to the electronic device 110, the blockchain interface server 120, or the blockchain nodes 130. Further, for explanatory purposes, the periods of the process 700 are described herein as occurring sequentially or linearly. However, multiple periods of the process 700 may occur in parallel. In addition, the periods of the process 700 need not be performed in the order shown and/or one or more periods of the process 700 need not be performed and/or can be replaced by other operations.

At period 705, User A can receive a wallet address of a non-user recipient which User A will use to send blockchain assets associated with the channel previously established between the electronic device 110 and the blockchain interface server 120.

At period 710, User A may launch a digital wallet application on their electronic device 110. The digital wallet may provide an interface where User A can provide the received wallet address of the non-user recipient and an amount corresponding to the blockchain asset to be sent, for example, a number of data elements of the blockchain asset. In some implementations, a field may be prepopulated with the non-user wallet address based on the receipt of the wallet address at period 705. In some implementations, the wallet address may be previously received and stored in association with other identifying characteristics of the recipient non-user, for example in local storage of the electronic device 110. Thus, if the transaction was a repeat transaction, the recipient information may already be known to the electronic device 110 from the previous transaction and User A can select the recipient from a list based on a friendly name.

At period 715, prior to submitting the transaction to the applet in the secure element for processing, an authorization process can be used to verify that the user, e.g., User A, has authorization to transfer blockchain asset from the wallet application at the electronic device 110. In some implementations, the authorization process may be like unto the authorization process discussed above in connection with period 620. The authorization process may be conducted at other periods in the process 600, such as before or after period 705 or after period 725.

At period 720, the transaction data is provided to the applet in the secure element. The transaction data includes the wallet address of the non-user recipient and the amount of blockchain asset to be transferred. At period 725, the applet will process the transaction data and form a transaction including the recipient address. The applet will cryptographically sign the transaction using the private key and provide the signed transaction data or the signature alone to the wallet application at the electronic device 110.

At period 730, the wallet application uses the channel between the electronic device 110 and the blockchain interface server 120 to provide the transaction information including the transaction data and the signature to the blockchain interface server 120. And at period 735, the blockchain interface server 120 submits the transaction to the blockchain nodes 130.

At period 740, a settlement process will take place to validate the transaction, for example, by the blockchain nodes 130, add the transaction as a block to the blockchain, and distribute the updated blockchain information to all of the blockchain nodes 130. At period 745, during the settlement time, rather than the electronic device 110 monitor the blockchain ledger, the blockchain interface server 120 can refresh its ledger until it can verify that the transaction was recorded. Then at period 750 can issue a notification to the electronic device 110 via the wallet application. For example, the wallet application can be configured to notify User A via a notification element of the electronic device 110 when the transaction has been recorded.

At period 755, the payment is considered complete and settled back to the blockchain. In some implementations, when the blockchain asset is written back to the blockchain, the channel between the electronic device 110 and the blockchain interface server 120 may be released. In such implementations, User A may be prompted to recreate the channel using the same value of blockchain asset or a different value.

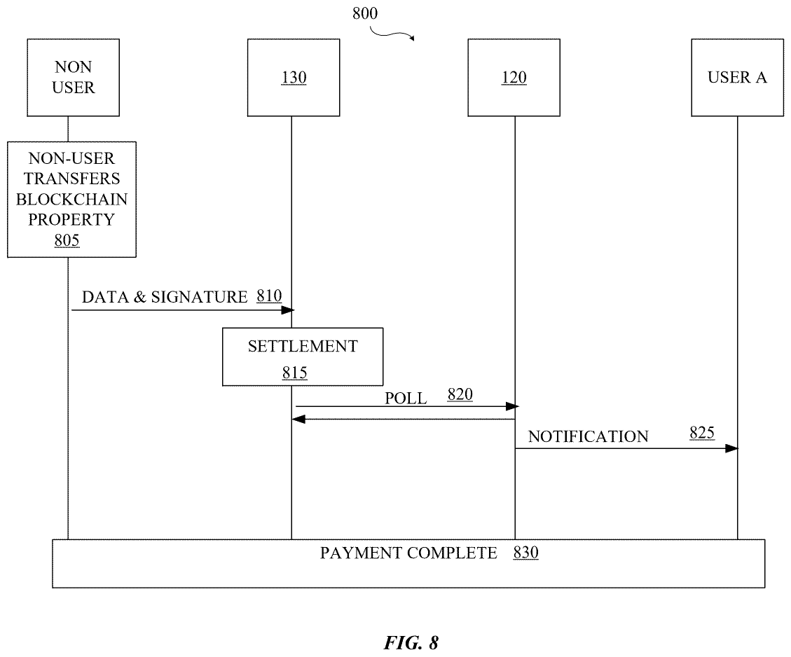

FIG. 8 depicts a sequence diagram of an example process 800 sending a blockchain asset from non-user to User A, where User A is a customer or user associated with the blockchain interface server 120 and the non-user is not. The electronic device 110 is associated with User A, e.g., belongs to User A or which User A is a primary user of, and includes a wallet application and an applet in a secure element, such as described above. For explanatory purposes, the process 800 is primarily described herein with reference to the electronic device 110, the blockchain interface server 120, and the blockchain nodes 130 of FIGS. 1-3. However, the process 800 is not limited to the electronic device 110, the blockchain interface server 120, or the blockchain nodes 130. Further, for explanatory purposes, the periods of the process 800 are described herein as occurring sequentially or linearly. However, multiple periods of the process 800 may occur in parallel. In addition, the periods of the process 800 need not be performed in the order shown and/or one or more periods of the process 800 need not be performed and/or can be replaced by other operations.

At period 805, a non-user can transfer a blockchain asset to User A utilizing a wallet address for User A. User A is a registered user of the blockchain interface server 120. User A may separately have a channel, such as a payment channel established between the electronic device 110 of User A and the blockchain interface server 120. The transaction, however, from the non-user to User A corresponds to an on-chain transaction. The wallet address for User A can correspond to a wallet application at the electronic device 110. In some implementations the wallet address for sending blockchain assets to User A can correspond to the address of the channel between the electronic device 110 and the blockchain interface server 120.

At period 810, the non-user will transfer data and a signature for the data to blockchain nodes 130 associated with the transaction. The signature, for example, may correspond to a private key signing of the transaction data from the non-user device. In such instances, the non-user device may correspond to a device of the same manufacturer as User A's electronic device 110, but the non-user device may either not be registered with the blockchain interface server 120 or may not have a previously established channel with the blockchain interface server 120, at least for the blockchain technology being used.

At period 815, the blockchain nodes 130 will undergo a settlement process for the transaction. For example, the blockchain nodes 130 will validate the transaction, form a block representing the transaction, calculate a hash value for the block, and add the block to the blockchain. Meanwhile at period 820, the blockchain interface server 120 may continuously poll the blockchain. When a recipient address of a wallet matching a user associated with the blockchain interface server 120 is discovered in the polling of the blockchain, in this case a wallet address of User A, the blockchain interface server 120 can recognize that one of its users has received a transaction of blockchain assets. In some implementations, when the wallet address corresponds to the channel address between the electronic device 110 and the blockchain interface server 120, the blockchain interface server 120 can recognize that the channel corresponding to the address is established between the electronic device 110 and the blockchain interface server 120 and act accordingly.

At period 825, the blockchain interface server 120 can send a notification to User A, for example, to the electronic device 110 or to another communication form, such as by an email or text message, or to the wallet application of the electronic device 110. The blockchain interface server 120 can receive the transaction data and the signature and provide the transaction information, via the notification to the wallet application of User A. The user may therefore have in their wallet application some blockchain assets which are allocated to the channel established between the electronic device 110 and may have other blockchain assets which are not allocated to the channel.

At period 830, the payment is considered complete and settled on the blockchain. The blockchain asset can show as available in the wallet application of User A at the electronic device 110.

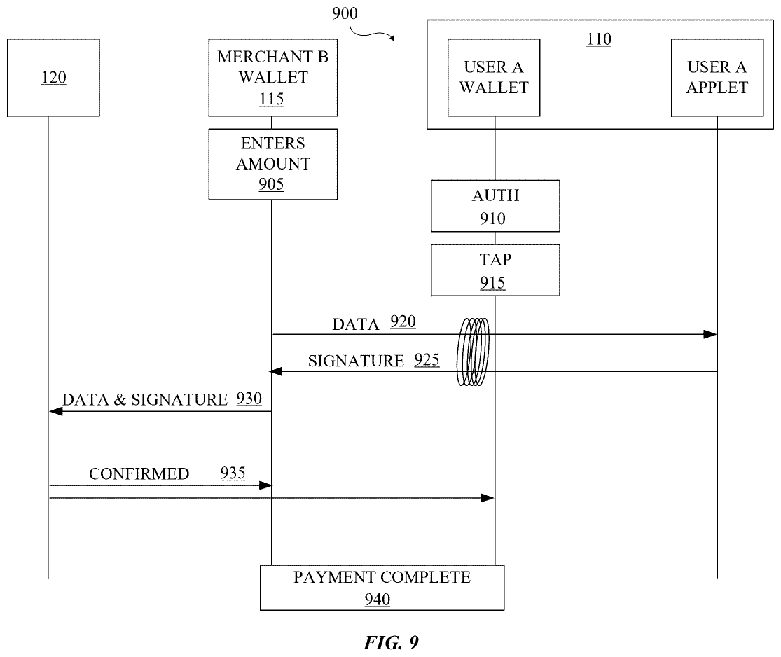

FIG. 9 depicts a sequence diagram of an example process 900 sending a blockchain asset from User A to a Merchant B, where both User A and Merchant B are customers or users associated with the blockchain interface server 120. The electronic device 110 is associated with User A, e.g., belongs to User A or which User A is a primary user of, and includes a wallet app and an applet in a secure element, such as described above. The electronic device 112 in this example is associated with Merchant B, e.g., belongs to Merchant B or which Merchant B is a primary user of, and includes a wallet app. It may also include an applet in a secure element, such as described above, however, the secure element of Merchant B is not utilized in this example. For explanatory purposes, the process 900 is primarily described herein with reference to the electronic device 110, the electronic device 112, which may correspond in this example to a point-of-sale device, and the blockchain interface server 120 of FIGS. 1-3. However, the process 900 is not limited to the electronic device 110, the electronic device 112, or the blockchain interface server 120. Further, for explanatory purposes, the periods of the process 900 are described herein as occurring sequentially or linearly. However, multiple periods of the process 900 may occur in parallel. In addition, the periods of the process 900 need not be performed in the order shown and/or one or more periods of the process 900 need not be performed and/or can be replaced by other operations.

The process 900 generally represents a transaction that a user may engage in at a place of business or over a website, where the transaction involves the transfer of blockchain asset in exchange for goods and/or services.

At period 905, a merchant can provide a total cost for providing the goods and/or services to User A. The total cost may be calculated at a point-of-sale device or may be entered, for example, at another electronic device of the Merchant B. User A may be provided with an option to select a currency for paying the cost corresponding to the amount requested by Merchant B. For example, Merchant B may enter a cost of 100 US Dollars, and User A may want to pay by a blockchain based asset and not US Dollars. Upon selecting the blockchain based asset of choice, a conversion may be displayed or otherwise provided by the Merchant B to allow User A to see the equivalent amount in the selected blockchain-based asset. The conversion data may be provided based on a real-time price conversion between the requested asset and the selected asset.

At period 910, User A may open their wallet application on the electronic device 110, and authenticate that they are authorized to use it, where the authentication may utilize any suitable authentication process, including those discussed above with respect to the period 620. User A may select the payment method in the wallet application corresponding to the payment method selected at the Merchant B's electronic device 112.

At period 915, the user may initiate a tap session (or another contactless session, such as scanning a QR code, or utilizing Bluetooth, UWB, or Wi-Fi, to authorize a transfer from the User A's wallet application at the electronic device 110 to the Merchant B's wallet application at the electronic device 112. The transfer, however, can be made off-chain utilizing the principles set forth above, that is, previously established channels between the electronic device 110 and the blockchain interface server 120 and between the electronic device 112 and the blockchain interface server 120. As the user taps (e.g., brings within NFC communication range) their electronic device having an NFC radio disposed therein, the NFC controller may capture data from the Merchant B corresponding to the transaction. Upon receiving the data, the secure element of the electronic device 110 may utilize the data to create a transaction with the Merchant B as the destination wallet address, and utilize a private key to sign the transaction data.

At period 920, the data associated with the transaction may be provided to the User A applet, including the address of the recipient wallet of the Merchant B. However, because the data may be provided over the contactless interface, the data can be provided directly to the applet in the secure element of the electronic device 110. Accordingly, the wallet address of the Merchant B may be kept private from User A.

At period 925, the applet can sign the transaction data with the private key of User A and provide the signature back to Merchant B's wallet app. At period 930, electronic device 112 may provide the transaction data and signature to the blockchain interface server 120.

At period 935, the blockchain interface server 120 can effectuate the transfer between the blockchain wallets of User A and Merchant B, for example, using the sever logic group functionality described above with respect to element 306 of FIG. 3, and send a confirmation to each of the wallet of User A and the wallet of Merchant B. Merchant B can advantageously receive the confirmation instantaneously, e.g., within seconds, due to the transaction being performed off-chain.

At period 940, the payment is considered complete. The blockchain asset transferred to Merchant B can show as being available in the wallet application of Merchant B at the electronic device 112.

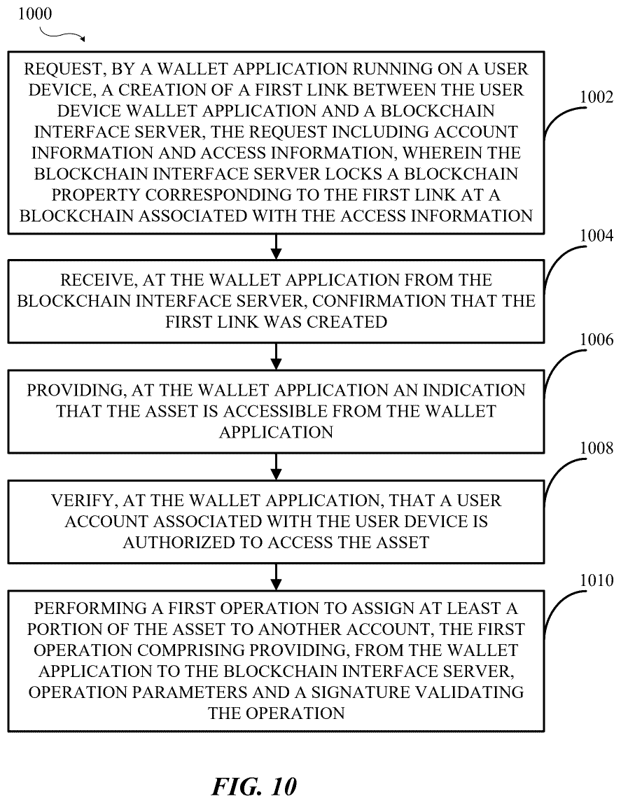

FIG. 10 depicts a flow diagram of an example process 1000 for establishing a channel between a user blockchain wallet and a blockchain interface server and using the channel to perform an operation transferring a blockchain asset, in accordance with one or more implementations. For explanatory purposes, the process 1000 is primarily described herein with reference to the electronic device 110 and/or 112 and the blockchain interface server 120 of FIGS. 1-3. However, the process 1000 is not limited to the electronic device 110 and/or 112 or the blockchain interface server 120. Further, for explanatory purposes, the blocks of the process 1000 are described herein as occurring sequentially or linearly. However, multiple blocks of the process 1000 may occur in parallel. In addition, the blocks of the process 1000 need not be performed in the order shown and/or one or more blocks of the process 1000 need not be performed and/or can be replaced by other operations.

As shown in FIG. 10, block 1002 of process 1000 may include requesting, by an application running on a device, such as the electronic device 110 and/or 112, a creation of a first link, such as a channel (e.g., a payment channel) between the application of the electronic device 110 and/or 112 and a blockchain interface server, such as the blockchain interface server 120. The request can include account information, such as an amount of a block chain asset to commit to the channel, and access information, such as an address of the channel to provide as well as, in some implementations a private key signed transaction to commit the blockchain asset to the first link. The blockchain interface server locks a blockchain asset corresponding to the first link at a blockchain associated with the access information. For example, the blockchain interface server can utilize the transaction information provided by the device, including the access information and the account information (and/or signature of the signed transaction information) to blockchain nodes associated with a blockchain technology and thereby cause the blockchain nodes to verify the transaction and lock the blockchain asset at the blockchain.

As also shown in FIG. 10, block 1004 of process 1000 may include receiving, at the application from the blockchain interface server, confirmation that the first link was created. The blockchain server, for example, can poll the blockchain and, when the blockchain asset becomes locked, send confirmation to the device.

As also shown in FIG. 10, block 1006 of process 1000 may include providing, at the application an indication that the blockchain asset is accessible from the application. The application, for example, can display a quantity corresponding to the blockchain asset that is available to send over the first link in an off-chain transaction. The application can further display another blockchain asset that is not locked at the blockchain and which is considered on-chain. The application can also display a value of the blockchain asset available for off-chain transactions in another currency, such as a local currency where the device is located.

As also shown in FIG. 10, block 1008 of process 1000 may include verifying, at the application, that a user account associated with the device is authorized to access the blockchain asset. For example, if a user wants to access their application and send a blockchain asset to another user or to a non-user, the application can provide an authorization process, such as a biometric authorization process or a multi-factor authorization process, such as discussed above, to ensure the user is authorized to use the application.

As also shown in FIG. 10, block 1010 of process 1000 may include performing a first operation to assign at least a portion of the blockchain asset to another device, the first operation having providing, from the application to the blockchain interface server, operation parameters and a signature validating the first operation. For example, the first operation can be to allocate some of the blockchain asset to another user. As operation parameters, the user can specify a receiving user by user id or username, or some other identifying factor, such as a user's wallet address. The user can also specify a transaction amount of a blockchain asset to provide to the receiving user. Operation parameters can also include a time delay property to delay the asset transfer, a recurring transfer property to repeatedly transfer an amount of a blockchain asset on a schedule, or a property to enforce a security policy, such as a parameter to require that the transfer be recorded to the blockchain rather than be made off chain. The application can retrieve the wallet address of the receiving user from the blockchain interface server and then pass the operation parameters and receiving wallet address to a secure element for the secure element to cryptographically sign the transaction. Then the application can transmit the operation parameters and the validation signature to the blockchain interface server, where, upon receipt, the blockchain interface server sends a notification to the recipient device indicating that a transfer was completed. The transfer can be completed instantaneously, e.g., within seconds.

In some implementations, the account identifier, e.g., receiving user's wallet address, is hidden at the device from the sending user, as a measure of privacy for the receiving user. The transfer can be completed without committing the operation to the blockchain until the first link is released, i.e. the transfer can be implemented off-chain.

In some implementations, the blockchain interface server polls a ledger of the blockchain to determine that at least the portion of the blockchain asset was recorded on the blockchain. That is, if the recipient is not a user of the blockchain interface server, then the transaction may be recorded on-chain by the blockchain interface server by writing the transaction to the blockchain nodes for validation and distribution. In such instances, the blockchain interface server monitors the ledger of the blockchain to determine when the settlement is complete and the blockchain asset was recorded on the blockchain.

In some implementations, the first operation further comprises: obtaining an address of an account associated with the blockchain; providing the address of the account and the operation parameters for at least the portion of the blockchain asset to a secure program running on the device to receive, from the secure program, a validation signature for the first operation; transmitting the operation parameters and the validation signature to the blockchain interface server, where, upon receipt, the blockchain interface server records a transfer of the at least the portion of the blockchain asset to a blockchain; and receiving, from the blockchain interface server, a notification that the transfer was completed, where the blockchain interface server polls the blockchain to determine if the transfer was completed.

In some implementations, process 1000 further includes releasing a first portion of the blockchain asset at the blockchain, where a second portion of the blockchain asset remains locked at the blockchain and an indication of the second portion of the blockchain asset is provided by the application.

In some implementations, the first operation further comprises: authorizing at the device, a payment prompted by the other device, where the authorizing is performed by a near-field communication (NFC) or by scanning a quick response (QR) code displayed at the other device. For example, if the transfer is between a customer and a merchant, then a tap pay process or a QR code can be scanned to obtain a wallet address of the merchant so the user at the device can pay the merchant without learning the merchant's wallet address directly.

In some implementations, process 1000 further includes receiving, at the application from the blockchain interface server, a notification that another blockchain asset was assigned to the application and access information corresponding to the other blockchain asset. For example, in some implementations a non-user may send a user a blockchain asset and the blockchain interface server can monitor the blockchain and to determine if the wallet address corresponding to the application of the device received blockchain asset recorded on the blockchain.

In some implementations, the application used in process 1000 may correspond to a digital wallet application running on a mobile device. In other implementations, for example, the application may correspond to another type of asset management application for interacting with blockchain assets.

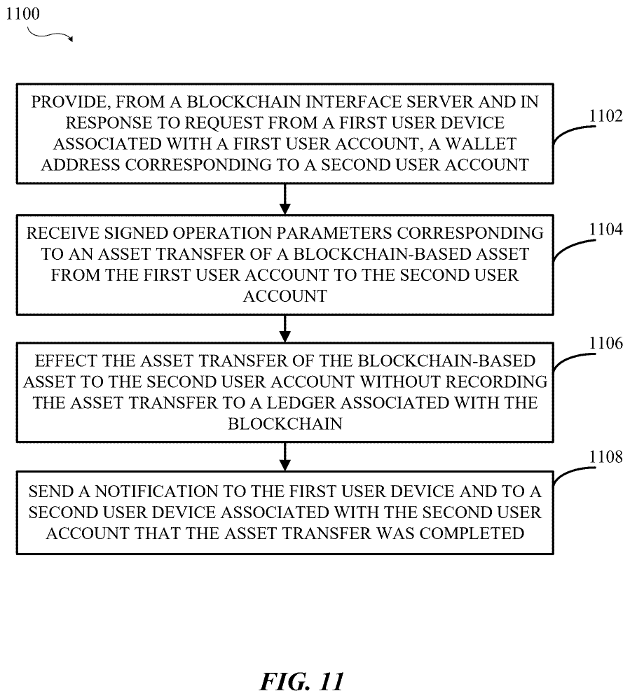

FIG. 11 depicts a flow diagram of an example process 1100 for establishing a channel between a user wallet and a blockchain interface server and using the channel to perform an operation transferring a blockchain asset, in accordance with one or more implementations. For explanatory purposes, the process 1100 is primarily described herein with reference to the electronic device 110 and/or 112 and the blockchain interface server 120 of FIGS. 1-3. However, the process 1100 is not limited to the electronic device 110 and/or 112 or the blockchain interface server 120. Further, for explanatory purposes, the blocks of the process 1100 are described herein as occurring sequentially or linearly. However, multiple blocks of the process 1100 may occur in parallel. In addition, the blocks of the process 1100 need not be performed in the order shown and/or one or more blocks of the process 1100 need not be performed and/or can be replaced by other operations.

As shown in FIG. 11, at block 1102 process 1100 may include providing, from a blockchain interface server and in response to request from a first user device associated with a first user account, a wallet address corresponding to a second user device. For example, the blockchain interface server may have received a user id of a second user account and a request for a wallet address corresponding to the user id. The blockchain interface server can look up the wallet address and return it back to the first user device.

As also shown in FIG. 11, at block 1104 process 1100 may include receiving signed operation parameters corresponding to an asset transfer of a blockchain-based asset from the first user account to the second user account. For example, when the first user device sends a blockchain-based asset, such as a blockchain asset to a second device via a wallet address, the first user device can use a preestablished channel between the first user device and the blockchain interface server to send the transaction to the blockchain interface server, which can then forward the transaction to another preestablished channel between the second user device and the blockchain interrace server. The signed operation parameters can include a transaction amount corresponding to the blockchain-based asset.

As further shown in FIG. 11, at block 1106 process 1100 may include effecting the asset transfer of the blockchain-based asset to the second user device without recording the asset transfer to a ledger associated with the blockchain. In other words, the transaction may be performed off-chain utilizing the previously established channels.

As also shown in FIG. 11, at block 1108 process 1100 may include sending a notification to the first user device and to a second user device associated with the second user account that the asset transfer was completed.

In some implementations, process 1100 further includes receiving a request from the first user device for a creation of a first link between the first user account and the blockchain interface server, the request including access information corresponding to a blockchain asset; and initiating an action to lock the blockchain asset on the blockchain, where after a settlement of the blockchain asset, the first link corresponding to the blockchain-based asset is created between the blockchain interface server and the first user account and the blockchain asset is locked at the blockchain. The first link, for example, can correspond to a channel, such as a payment channel, as described above.

In some implementations, the asset transfer is performed via the first link and a second link between the second user device and the blockchain interface server. The second link, for example, can correspond to another channel, such as a payment channel, between the second device and the blockchain interface server.

In some implementations, process 1100 further includes effecting a recording of the blockchain asset to the ledger associated with the blockchain. In such implementations, the transaction may correspond to a non-user wallet address which is then written in a block to the blockchain.

In some implementations, the blockchain interface server is prevented from redirecting the asset transfer to another account based on a security protocol associated with the signed operation parameters. For example, because the recipient is specified as corresponding to a recipient wallet address, the blockchain interface server can only forward a transaction to the recipient wallet and has no way of holding any of the blockchain assets associated with the transaction.

FIG. 12 depicts an example electronic system 1200 with which aspects of the present disclosure may be implemented, in accordance with one or more implementations. The electronic system 1200 can be, and/or can be a part of, any electronic device for generating the features and processes described in reference to FIGS. 1-9, including but not limited to a laptop computer, tablet computer, smartphone, and wearable device (e.g., smartwatch, fitness band). The electronic system 1200 may include various types of computer-readable media and interfaces for various other types of computer-readable media. The electronic system 1200 includes one or more processing unit(s) 1214, a persistent storage device 1202, a system memory 1204 (and/or buffer), an input device interface 1206, an output device interface 1208, a bus 1210, a ROM 1212, one or more processing unit(s) 1214, one or more network interface(s) 1216, a secure element 1218, and/or subsets and variations thereof.

The bus 1210 collectively represents all system, peripheral, and chipset buses that communicatively connect the numerous internal devices of the electronic system 1200. In one or more implementations, the bus 1210 communicatively connects the one or more processing unit(s) 1214 with the ROM 1212, the system memory 1204, and the persistent storage device 1202. From these various memory units, the one or more processing unit(s) 1214 retrieves instructions to execute and data to process in order to execute the processes of the subject disclosure. The one or more processing unit(s) 1214 can be a single processor or a multi-core processor in different implementations.

The ROM 1212 stores static data and instructions that are needed by the one or more processing unit(s) 1214 and other modules of the electronic system 1200. The persistent storage device 1202, on the other hand, may be a read-and-write memory device. The persistent storage device 1202 may be a non-volatile memory unit that stores instructions and data even when the electronic system 1200 is off. In one or more implementations, a mass-storage device (such as a magnetic or optical disk and its corresponding disk drive) may be used as the persistent storage device 1202.

In one or more implementations, a removable storage device (such as a floppy disk, flash drive, and its corresponding disk drive) may be used as the persistent storage device 1202. Like the persistent storage device 1202, the system memory 1204 may be a read-and-write memory device. However, unlike the persistent storage device 1202, the system memory 1204 may be a volatile read-and-write memory, such as RAM. The system memory 1204 may store any of the instructions and data that one or more processing unit(s) 1214 may need at runtime. In one or more implementations, the processes of the subject disclosure are stored in the system memory 1204, the persistent storage device 1202, and/or the ROM 1212. From these various memory units, the one or more processing unit(s) 1214 retrieves instructions to execute and data to process in order to execute the processes of one or more implementations.

The bus 1210 also connects to the input device interfaces 1206 and output device interfaces 1208. The input device interface 1206 enables a user to communicate information and select commands to the electronic system 1200. Input devices that may be used with the input device interface 1206 may include, for example, alphanumeric keyboards, touch screens, and pointing devices. The output device interface 1208 may enable the electronic system 1200 to communicate information to users. For example, the output device interface 1208 may provide the display of images generated by electronic system 1200. Output devices that may be used with the output device interface 1208 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

The bus 1210 also connects to secure element 1218. The secure element 1218 may include hardware and/or software that provides secure storage and management of sensitive information. The secure element 1218 may be isolated from the processing unit 1214 and operating system, making it more difficult for unauthorized access. The secure element 1218 may be used for secure transactions and identification, such as in payment cards and digital passes. The secure element 1218 may store sensitive information, such as cryptographic keys, and may protect the sensitive information (e.g., with cryptographic algorithms and access controls).

Finally, as shown in FIG. 12, the bus 1210 also couples the electronic system 1200 to one or more networks and/or to one or more network nodes through the one or more network interface(s) 1216. In this manner, the electronic system 1200 can be a part of a network of computers (such as a local area network, a wide area network, an Intranet, or a network of networks, such as the Internet). Any or all components of the electronic system 1200 can be used in conjunction with the subject disclosure.

Implementations within the scope of the present disclosure can be partially or entirely realized using a tangible computer-readable storage medium (or multiple tangible computer-readable storage media of one or more types) encoding one or more computer-readable instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessors or multi-core processors that execute software, one or more implementations are performed by one or more integrated circuits, such as ASICs or FPGAs. In one or more implementations, such integrated circuits execute instructions that are stored on the circuit itself.

As described above, one aspect of the present technology is the gathering and use of data available from specific and legitimate sources for blockchain asset transfer. The present disclosure contemplates that in some instances, this gathered data may include personal information data that uniquely identifies or can be used to identify a specific person. Such personal information data can include demographic data, location-based data, online identifiers, telephone numbers, email addresses, home addresses, images, videos, audio data, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, personal information data can be used for file sharing. Accordingly, the use of such personal information data may facilitate transactions (e.g., online transactions). Further, other uses for personal information data that benefit the user are also contemplated by the present disclosure. For instance, health and fitness data may be used, in accordance with the user's preferences to provide insights into their general wellness or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates implementations in which users selectively block the use of, or access to, personal information data. That is, the present disclosure contemplates that hardware and/or software elements can be provided to prevent or block access to such personal information data. For example, in the case of file sharing, the present technology can be configured to allow users to select to “opt-in” or “opt-out” of participation in the collection of personal information data during registration for services or anytime thereafter. In addition to providing “opt-in” and “opt-out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed implementations, the present disclosure also contemplates that the various implementations can also be implemented without the need for accessing such personal information data. That is, the various implementations of the present technology are not rendered inoperable due to the lack of all or a portion of such personal information data.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, one or more implementations, an embodiment, the embodiment, another embodiment, one or more implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any implementation described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

1. A method comprising:
requesting, by an application running on a device, a creation of a first link between the application and a blockchain interface server, the request including account information and access information, wherein the blockchain interface server locks a blockchain asset corresponding to the first link at a blockchain associated with the access information;
receiving, at the application from the blockchain interface server, confirmation that the first link was created;
providing, at the application an indication that the blockchain asset is accessible from the application;
verifying, at the application, that a user account associated with the device is authorized to access the blockchain asset; and
performing a first operation to assign at least a portion of the blockchain asset to another device, the first operation comprising providing, from the application to the blockchain interface server, operation parameters and a signature validating the first operation.

2. The method of claim 1, wherein the first operation further comprises:
requesting an account identifier of a recipient based on a user id associated with an account registered at the blockchain interface server;
receiving the account identifier of the recipient;
providing the account identifier of the recipient and the operation parameters for at least the portion of the blockchain asset to a secure program running on the device to receive, from the secure program, a validation signature for the first operation; and
transmitting the operation parameters and the validation signature to the blockchain interface server, wherein, upon receipt, the blockchain interface server sends a notification to the other device derived from the operation parameters associated with the first operation, the notification indicating that a transfer was completed.

3. The method of claim 2, wherein the account identifier is hidden at the device.

4. The method of claim 1, wherein the first operation is kept from the blockchain.

5. The method of claim 1, wherein the verification of the user account includes a biometric validation of a user of the device.

6. The method of claim 1, wherein the blockchain interface server polls a ledger of the blockchain to determine that at least the portion of the blockchain asset was recorded on the blockchain.

7. The method of claim 1, wherein the first operation further comprises:
obtaining an address of an account associated with the blockchain;
providing the address of the account and the operation parameters for at least the portion of the blockchain asset to a secure program running on the device to receive, from the secure program, a validation signature for the first operation;
transmitting the operation parameters and the validation signature to the blockchain interface server, wherein, upon receipt, the blockchain interface server records a transfer of the at least the portion of the blockchain asset to a blockchain; and
receiving, from the blockchain interface server, a notification that the transfer was completed, wherein the blockchain interface server polls the blockchain to determine if the transfer was completed.

8. The method of claim 1, further comprising:
releasing a first portion of the blockchain asset at the blockchain, wherein a second portion of the blockchain asset remains locked at the blockchain and an indication of the second portion of the blockchain asset is provided by the application.

9. The method of claim 1, wherein the first operation further comprises:
authorizing at the device, a payment prompted by the other device, wherein the authorizing is performed by a near-field communication (NFC) or by scanning a quick response (QR) code displayed at the other device.

10. The method of claim 1, further comprising:
receiving, at the application from the blockchain interface server, a notification that another blockchain asset was assigned to the application and access information corresponding to the other blockchain asset.

11. The method of claim 1, wherein the application corresponds to a digital wallet application running on a mobile device.

12-17. (canceled)

18. A device comprising:
one or more processors; and
a non-transitory computer-readable memory storing instructions, configured to cause the one or more processors to:
request, by a application, a creation of a first link between the application and a blockchain interface server, the request including account information and access information, wherein the blockchain interface server locks a blockchain asset corresponding to the first link at a blockchain associated with the access information;
receive, at the application from the blockchain interface server, confirmation that the first link was created;
provide, at the application an indication that the blockchain asset is accessible from the application;
verify, at the application, that a user account associated with the device is authorized to access the blockchain asset; and
perform a first operation to assign at least a portion of the blockchain asset to another device, the first operation comprising providing, from the application to the blockchain interface server, operation parameters and a signature validating the first operation.

19. The device of claim 18, wherein the first operation further comprises:
requesting an account identifier of a recipient based on a user id associated with an account registered at the blockchain interface server;
receiving the account identifier of the recipient;
providing the account identifier of the recipient and the operation parameters for at least the portion of the blockchain asset to a secure program running on the device to receive, from the secure program, a validation signature for the first operation; and
transmitting the operation parameters and the validation signature to the blockchain interface server, wherein, upon receipt, the blockchain interface server sends a notification to the other device derived from the operation parameters associated with the first operation, the notification indicating that a transfer was completed.

20. The device of claim 18, wherein the first operation further comprises:
obtaining an address of an account associated with the blockchain;
providing the address of the account and the operation parameters for at least the portion of the blockchain asset to a secure program running on the device to receive, from the secure program, a validation signature for the first operation;
transmitting the operation parameters and the validation signature to the blockchain interface server, wherein, upon receipt, the blockchain interface server records a transfer of the at least the portion of the blockchain asset to a blockchain; and
receiving, from the blockchain interface server, a notification that the transfer was completed, wherein the blockchain interface server polls a blockchain ledger to determine if the transfer was completed.

21. A computer-readable medium storing instructions thereon, which when executed by one or more processors, cause the one or more processors to:
request, by an application running on a device, a creation of a first link between the application and a blockchain interface server, the request including account information and access information, wherein the blockchain interface server locks a blockchain asset corresponding to the first link at a blockchain associated with the access information;
receive, at the application from the blockchain interface server, confirmation that the first link was created;
provide, at the application an indication that the blockchain asset is accessible from the application;
verify, at the application, that a user account associated with the device is authorized to access the blockchain asset; and
perform a first operation to assign at least a portion of the blockchain asset to another device, the first operation comprising providing, from the application to the blockchain interface server, operation parameters and a signature validating the first operation.

22. The computer-readable medium of claim 21, wherein the first operation further comprises:
requesting an account identifier of a recipient based on a user id associated with an account registered at the blockchain interface server;
receiving the account identifier of the recipient;
providing the account identifier of the recipient and the operation parameters for at least the portion of the blockchain asset to a secure program running on the device to receive, from the secure program, a validation signature for the first operation; and
transmitting the operation parameters and the validation signature to the blockchain interface server, wherein, upon receipt, the blockchain interface server sends a notification to the other device derived from the operation parameters associated with the first operation, the notification indicating that a transfer was completed.

23. The computer-readable medium of claim 22, wherein the account identifier is hidden at the device.

24. The computer-readable medium of claim 21, wherein the first operation is kept from the blockchain.

25. The computer-readable medium of claim 21, wherein the blockchain interface server polls a ledger of the blockchain to determine that at least the portion of the blockchain asset was recorded on the blockchain.

26. The computer-readable medium of claim 21, wherein the application corresponds to a digital wallet application running on a mobile device.
